(19) United States
(12) Patent Application Publication
(10) Pub. No.: US 2012/0262910 A1
(43) Pub. Date: Oct. 18, 2012

(54) Light Refraction Religious Lamp Device

(76) Inventor: Leticia Ledesma, Chicago, IL (US)

(21) Appl. No.: 13/423,921

(22) Filed: Mar. 19, 2012

Related U.S. Application Data
(60) Provisional application No. 61/476,464, filed on Apr. 18, 2011.

(51) Int. Cl. F21S 6/00

(52) U.S. Cl. 362/121

(57) ABSTRACT

An illuminated religious cross device is disclosed having an ornamental religious shape, a plurality of internal light sources and a refracting crystal to provide a pattern of disbursed light projecting from the cross and accompanied by soft, ambient lighting shining through the translucent device body. The device body has a general cross shape attaching to a base structure, wherein a refracting crystal is positioned at the center of the cross. A plurality of light sources connect to a control switch along the base structure, wherein the light sources project through the translucent lamp body surfaces, crystal and through a forward face of the base structure. The forward face further provides a stencil cutout for projecting a message, while the refracting light provides a distinct pattern of light for a spiritual atmosphere. Power may be provided to the device via an A/C electrical connection or an internal battery supply.

### CROSS REFERENCE TO RELATED APPLICATION

This application claims the benefit of U.S. Provisional Application No. 61/476,464 filed on Apr. 18, 2011, entitled “Light of the World.”

### BACKGROUND OF THE INVENTION

1. Field of the Invention

The present invention relates to lamps and illuminated religious objects that provide a soothing, spiritual atmosphere and ambient lighting. More specifically, the present invention pertains to a religious cross structure forming a lamp having a centrally located, light refracting crystal to project light in a unique pattern or dispersement, along with soft lighting through the translucent lamp body and the base structure.

Many spiritual and religious activities are best suited for soothing atmospheres, where one feels comfortable and at peace. Generally the use of candle light or softer lighting is provided to allow for concentration and deep thinking. Religious objects and icons are also included in such an atmosphere, wherein the spiritual activity may be directed to a specific entity or object. Individuals and groups of people during prayer services or other religious meetings often enjoy this type of soft, ambient lighting, for these environments are conducive to reflective thinking and further alleviate distress. Candles and low-lit lamps utilized to achieve this desired atmospheric lighting may create attractive, decorative glows; however they often do not provide sufficient illumination, and further create a potential hazard for users if many candles are simultaneously lit.

The present invention is related to a light source that is both functional as well as uplifting. The goal of the present invention is not just to provide lighting, but to provide a soothing ambiance, a distinct source of scattered light that draws attention and awe, and further allows users to relax while attending to spiritual and religious activities. The device comprises a lamp structure in the shape of a religious cross. The lamp has a hollow body section attached to a supportive base. The body provides a means to project both soothing lighting, as well as refracted light projected through a crystal structure at the center of the cross. The forward face of the base is further adapted to provide an uplifting or religious message.

2. Description of the Prior Art

Devices have been patented and published in the art that relate to illuminated cross devices. These devices have familiar design features for the purposes of creating an illuminating structure in the form of a religious cross. Most provide translucent or transparent panels to allow an internal light source to project through the cross body, while further still other devices provide novel means of projecting the light or allowing for extended use without grid power. These devices, however, fail to provide a device that provides ambient lighting through their body structures while also providing a projection of scattered light whereby an internal light source is shone through a refracting crystal. This scattered light creates a unique pattern and an interesting projection of light from the center of the cross. The goal is to improve its spiritual qualities while also providing a functional lamp device for various activities and environments. The following prior art devices are considered the most relevant to the present disclosure.

Specifically, U.S. Pat. No. 5,255,170 to Plamp discloses a memorial comprising a three dimensional monument having an illumination means. The illumination means includes a plurality of light sources arranged on said monument and controlled by a light detection means and a control means. The lights are arranged on the monument, which is in the shape of a religious cross, such that the lights provide discrete placement of lights to radiate outward and appear as illuminating star-like objects. The Plamp device describes a lighted cross of similar intent, however its construction and means of providing illumination differ with regard to the present invention.

U.S. Pat. No. 5,564,816 to Arcadia is another device that discloses an illuminated memorial for use at a grave site and utilizing photovoltaic power generation to allow prolonged, independent use thereof. The device comprises a hollow structure forming a religious cross and further having a central aperture for which to project light from the hollow interior. A photovoltaic power source is supported at the highest point on the hollow structure, while the light within the hollow is adapted to be projected in a pattern described by the aperture. While providing a similarly structured device, the Arcadia device is adapted for use at a grave site for prolonged, independent operation. The present invention is intended for prayer services, indoor use and for creating a warm ambiance. The construction and intent differ from the present invention, which provides a means to refract light into an interesting and decorative pattern, along with a plurality of internal lights to supplement the refracted light with softer tones.

Further, U.S. Pat. No. 1,614,703 to Wolfers discloses an illuminated cross that lights the entire cross and projects its rays in various directions. A central light bulb is positioned in the central, hollow region of the cross to project light through the translucent surfaces of the cross for the purposes of providing a uniquely shaped and ornamental lamp device. This device provides an illuminating lamp in the shape of a cross, but similarly fails to disclose the novel elements of the present invention, which provides a means to scatter light in an interesting and distinct pattern based on a refracting crystal attached to its body structure.

U.S. Pat. No. 1,524,835 to Mattern discloses an elongated lamp box in the shape of a cross, which can be readily folded and transported. The device comprises an elongated cross comprising a vertically extending hollow box and a pair of laterally extending hollow boxes, which can be folded against one another to condense its overall shape. A convex colored glass strip provides a translucent member for which to project light through the cross body from internal light bulbs. Similar to the Wolfers patent, the Mattern device fails to disclose an illuminated cross having the features of the present invention.

U.S. Pat. No. 2,427,655 to Blankenship discloses an improvement to religious crosses for use on church steeples, roofs and other structure where the cross is apt to be displayed. The device provides an imbedded illumination means for providing visualization of the cross structure over greater distances than its non-illuminated counterpart. The cross itself is of transparent or translucent material for projecting light therethrough, along with a rotatable base adapted to be driven by a motor assembly, rotating the cross member along a vertical axis for visualization in all outward directions. While providing a rotating and illuminated cross structure, the Blankenship device fails to disclose such a device having a light scattering means that refracts light into a pattern that draws attention and is awe-inspiring to on-lookers. The present invention provides such a means, along with softer, ambient lighting from the translucent body of the cross structure.

U.S. Pat. No. 4,453,201 to Prouty discloses another illuminating cross having a frame consisting of pairs of vertical and horizontal plates intersecting at notches to form a T-shaped cross. The front and back portion of the cross members are covered by sheets of translucent material, wherein imbedded lights provide illumination from within the cross body. The Prouty device provides a novel means for constructing the structure of the cross and for supporting its elements. A plurality of segments having notches are fitted together to create the hollow cross structure, within which are placed illumination means. The Prouty device suffers similar failings as the aforementioned devices, and does not disclose the novel features of the present invention.

Finally, U.S. Pat. No. 2,493,991 to Morrison discloses an ornamental illuminated cross object being of hollow construction and having a central disc. The disc provides ornamentation and is located at the intersection of the cross arm portions. The base of the cross and arms are able to transmit light rays from an internal light source throughout their respective lengths. The Morrison device provides a cross structure with internal lighting, but fails to disclose a light refracting means of the present invention. The present invention provides a novel light scattering element that adds to the visual nature of the cross, and further provides soothing ambient light through the cross body surfaces.

The present invention provides a unique means of scattering light from a lighted cross structure, which increases the spiritual qualities of the device and provides an interesting perspective for onlookers visualizing the scattered streams of light emanating from the center for the cross structure. The foregoing prior art devices describe similarly structured lamps and religious crosses having internal illumination means, but fail to disclose the novel aspects of the present invention. It is submitted that the present invention substantially diverges in design elements from the prior art, and consequently it is clear that there is a need in the art for an improvement to existing illuminated religious cross devices. In this regard the instant invention substantially fulfills these needs.

### SUMMARY OF THE INVENTION

In view of the foregoing disadvantages inherent in the known types of illuminated religious cross devices now present in the prior art, the present invention provides a new illuminated religious cross wherein the same can be utilized for providing convenience for the user when providing a unique projection of light therefrom, while also providing soft, ambient lighting to facilitate a calm atmosphere for spiritual and religious activities.

It is therefore an object of the present invention to provide a new and improved illuminated religious cross device that has all of the advantages of the prior art and none of the disadvantages.

It is another object of the present invention to provide a spiritual object having an internal illuminating means having both functional and decorative features, utilized for creating a soft lighting atmosphere while also providing a source of scattered light to uplift onlookers.

Another object of the present invention is to provide an illuminated religious cross device having a transparent body structure for projecting soft lighting within an interior room.

Yet another object of the present invention is to provide an illuminated religious cross device having a light refracting means that scatters light from the device in a unique and interesting pattern, adding to its spiritual quality.

A final object of the present invention is to provide an illuminated religious cross device having a base structure with an illuminated message along its forward face.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a frontal perspective view of the illuminated religious cross device.

FIG. 2 shows a side view of the illuminated religious cross device and its internal structure.

### DETAILED DESCRIPTION OF THE INVENTION

Reference is made herein to the attached drawings. Like reference numerals are used throughout the drawings to depict like or similar elements of the illuminated religious cross device. For the purposes of presenting a brief and clear description of the present invention, the preferred embodiment will be discussed as used for providing both soft lighting and a scattered projection of light adapted for spiritual or religious activities. The figures are intended for representative purposes only and should not be considered to be limiting in any respect.

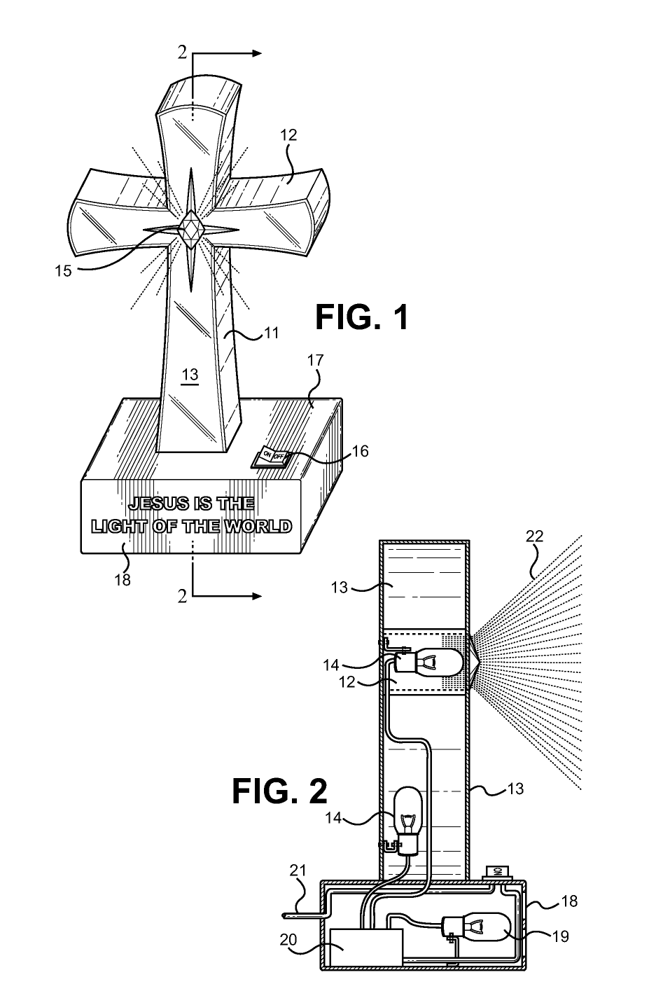

Referring now to FIG. 1, there is shown a frontal perspective view of the illuminated religious cross device of the present invention in a working position. The cross device comprises a base structure 17 that provides a stable platform for supporting the upstanding, vertical member 11 of the religious cross and its cross member 12, while also providing a hollow interior structure for housing the internal wiring that controls the operation of a plurality of lights within the device. Along the forward face 18 of the base structure 17 may be provided a stencil cutout forming a message for onlookers to read, such as an inspirational message or religious quotation. An internal light bulb or similar illumination means from within the base 17 and in proximity to the forward face 18 allows light to be projected through the stencil cutout to easily read the words created thereon in low light and normal lighting conditions. Also provided along the exterior of the base structure 17 is a power switch 16, which controls the flow of current from an internal power supply or from wall outlet power to the internal illumination means.

The upstanding cross is centrally positioned on the upper surface of the support structure 17, and comprises an upstanding portion 11 and a lateral cross member 12 to form a religious cross having an internal volume. The internal volume is a hollow region for which a plurality of light bulbs or similar illumination means is positioned. The forward face 13 is a translucent surface that allows light to project therethrough for creating a soft lighting atmosphere. The translucent surface may be slightly opaque to remove any harsh quality from the internal light sources, softening the lighting shining therethrough. In an alternate embodiment, more than one surface of the upstanding cross is translucent to allow light to project in multiple directions therefrom.

Centrally located at the intersection of the cross upstanding portion 11 and the lateral cross member 12 is a light refracting means 15, such as a glass crystal, diamond or similar natural or artificial structure that is adapted to refract lighting as it passes therethrough. A light source is positioned just behind this structure 15, wherein its projected light is refracted in a unique pattern of light, which adds to the visual and spiritual qualities of the present device. The refracting means 15 provides a visual quality that mimics a star, glimmer or similar spiritual or religious source of light that is both uplifting and inspiring for those visualizing the cross. Light scatters in a unique and defined pattern from the refracting means 15, sending rays of light in different directions such that onlookers are provided a unique perspective as they move in relation to the position of the cross.

Referring now to FIG. 2, there is shown a side view of the illuminated religious cross device of the present invention, along with a section view of its internal structure and the elements that facilitate its illumination qualities. Both the base structure and the upstanding cross are hollow structures that provide space for internal light sources 14, 19. At least one light source 19 is positioned within the base structure and in close proximity to the stencil cutout of the forward face 18. Light is projected through the stencil to allow its message to be easily read and understood. Also positioned within the base structure are a junction box 20, an optional power supply or incoming outlet power wiring 21, and electrical connections to each light source within the device. The switch along the base structure is wired between the power supply (or incoming power) and the junction box 20, and allows the user to prevent or allow the flow of current to the light sources as desired.

Along the interior of the upstanding cross of the present device is located at least one light source 14 directly behind the centrally located light refracting means. This light source is projected through a crystal, diamond or similar structure for refracting light in a unique pattern 22 from the center of the cross. Further light sources 14 may be provided within the upstanding portion of the cross or within its cross members for providing illumination through translucent panels 13 along the cross. These extra light sources provide softer, ambient lighting that compliments the directed light 22 from the refracting means. Each of the light sources is wired to the junction box 20, which provides a central connection that routes current from a power supply or incoming outlet power to the bulbs. The light sources are further secured within the interior of the cross structure utilizing brackets or clips, which attach to light sockets or the light source frames to firmly secure their position while allowing for ease of light replacement if a bulb burns out. Access to the bulbs may be provided through removable access panels along the rear of the cross and the base structure, which allows direct access to the bulbs for removal and installing of new bulbs.

The light refracting means 15 of the present invention is a new and novel aspect of the present illuminated cross, and provides users with a unique view of the device that is both uplifting and inspiring, and aligned with the goal of providing an illuminated spiritual or religious icon. The refracting means itself is any object that refracts or disperses light in a pattern. This can include crystalline materials, manufactured acrylic structures, an enclosed volume of water or any other suitable structure that scatters, disperses or refracts light from a light source positioned therebehind. The present invention provides a configuration that projects light directly through this structure to bend and disperse light into an interesting pattern, providing a unique view for onlookers and users.

Overall, the present invention provides a spiritual lamp device having a unique light dispersement emanating from the center thereof, while providing softer lighting from the body of the device and an enlightened message or passage highlighted along its base structure. The device is adapted to replace or complement candle lighting for religious activities, prayer services or similar spiritual environments. The present invention is designed to sufficiently illuminate a room while providing a spiritual atmosphere. The device provides a lamp constructed in the shape of a cross, while beams of light from the cross are refracted outwards, creating decorative light patterns and complementing the rest of the device's soft, ambient glow. The device is ideal for use in homes, churches, funeral homes, and other venues in which religious or spiritual lighting may be desired.

The present invention comprises a lamp that may be constructed of a unitary structure, such as molded glass, or alternatively constructed in attachable segments. The terminal ends of the cross may be rounded in shape, squared or provided in any ornamental design desired by the user, falling within the scope of providing an illuminating device having a light refracting means. The base may be constructed of a heavier material to provide a secure footing for the upstanding portion of the device. The stencil along its forward face is desired to provide a unique message. One such message contemplated is: “Jesus is the light of the world,” wherein the letters of these words are removed material to allow light to shine therethrough from within the interior of the base. A removable plate on the base and optionally the upstanding cross can be removed to afford users access to light sources contained therewithin. It is contemplated to have at least one bulb in the base and one bulb behind the refracting crystal. An exemplary embodiment contemplates one bulb located within the base for illuminating the stenciled phrase, one bulb placed toward the foot of the cross, and a third bulb located at the intersection of the arms of the cross and behind the refracting means. An additional cross-shaped embellishment, made of light blue crystal or similarly translucent material, may be positioned over or around the refracting means to be visible around this structure. Embodiments of the light sources include halogen bulbs, fluorescent bulbs and finally light emitting diodes (LEDs) and associated circuitry therefor.

In light of the present disclosure and a review of the prior art, it is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An illuminated cross device, comprising:
a base structure, an upstanding cross having a vertical region and a cross member intersecting said vertical region;
said base and said cross having sidewalls and an open interior volume;
a light refracting means positioned on one of said cross sidewalls;
at least one light source within said upstanding cross and positioned behind said light refracting means to shine light from said interior volume and through said refracting means;
a power switch for controlling the flow of current from a power source and through said light source.

2. The device of claim 1, wherein said upstanding cross and said base structure have a forward face, said upstanding cross forward face being translucent to allow light to shine therethrough.

3. The device of claim 1, wherein said upstanding cross and said base structure have a forward face, said base structure forward face having a stencil cutout of a message or phrase, wherein a light source is positioned in said base structure to shine light through said cutout.

4. The device of claim 1, wherein at least one of said upstanding cross sidewalls is translucent to allow light to shine therethrough.

5. The device of claim 1, wherein said refracting means is a crystalline material adapted to scatter or refract incoming light.

6. The device of claim 1, wherein said refracting means is glass crystal adapted to scatter or refract incoming light.

7. The device of claim 1, wherein said refracting means is a volume of water adapted to scatter or refract incoming light.

8. The device of claim 1, wherein said power source is an internal battery pack within said base structure.

9. The device of claim 1, wherein said power source is A/C power provided via a wall outlet power cord.

10. The device of claim 1, further comprises at least one access panel to allow access to said light sources for replacement thereof.

11. The device of claim 1, wherein said upstanding cross comprises a unitary glass structure.

12. The device of claim 1, wherein said light refracting means is centrally positioned at said upstanding cross vertical member and cross member intersection.
